(19) United States
(12) Patent Application Publication
(10) Pub. No.: US 2023/0202075 A1
(43) Pub. Date: Jun. 29, 2023

(54) CLOSING DEVICE FOR A MOLD GROUP

(71) Applicant: PERSICO S.P.A., Nembro (Bergamo) (IT)

(72) Inventors: Claudia PERSICO, Nembro (Bergamo) (IT); Dario BOMBARDIERI, Nembro (Bergamo) (IT); Stefano UBERTI, Nembro (Bergamo) (IT)

(21) Appl. No.: 17/926,977

(22) PCT Filed: Jun. 23, 2021
(86) PCT No.: PCT/IB2021/055534

§ 371 Date: Nov. 21, 2022

(30) Foreign Application Priority Data
Jun. 23, 2020 (IT) 102020000015055

(51) Int. Cl. B29C 33/28; B29C 41/06; B29C 41/38; F16B 1/00; F15B 15/20

(52) U.S. Cl. CPC B29C 33/28; B29C 41/06; B29C 41/38; F16B 1/0057; F15B 15/20

(57) ABSTRACT

A closing device for a mold group with two half-molds extends along a main axis and has a device body mountable to one of the two half-molds, and a closing group having a closing element rotatable about a rotation axis between a closing position, in which the two half-molds are lockable and an opening position, in which the two half-molds are releasable. A movement group housed in the device body and engaged with the closing group to rotationally move the closing element has a stem movable along the main axis and transmission members for transforming linear motion of the stem into rotatory motion of the closing element. A command group has a command plate engaged with one command end of the stem and a metal sealing bellows engaged with the command plate. A position of the metal sealing bellows corresponds to an axial position of the command plate and of the stem.

### CROSS-REFERENCE TO RELATED APPLICATIONS

This application is a National Phase Application of PCT International Application No. PCT/IB2021/055534, having an International Filing Date of Jun. 23, 2021 which claims the benefit of priority to Italian Patent Application No. 102020000015055, filed Jun. 23, 2020, each of which is hereby incorporated by reference in its entirety.

### FIELD OF THE INVENTION

The present invention relates to a closing device for a mold group of a molding system, preferably of the rotational type. In addition, the present invention relates to a mold group of a molding system, preferably of rotational type, comprising at least one closing device. Furthermore, the present invention relates to a molding system, preferably of rotational type, comprising a mold group provided with at least one closing device.

In particular, the present invention relates to the field of rotational molding of plastic materials; “rotational” molding means the molding technique in which hollow products are made starting from polymers of various kinds.

### BACKGROUND OF THE INVENTION

The steps of the rotational molding technique and the rotational molding equipment by means of which the technique is performed are well-known in the prior art.

Indeed, the rotational molding technique firstly provides placing a predetermined amount of polymeric material in liquid or powder form inside a mold group. Subsequently, the mold group is moved, usually in rotation around two perpendicular axes, and at the same time it is object of heating, so that the polymeric material inside the mold group, heated and moved, layers on the walls of the mold group itself. Finally, the mold group is cooled and, after it is reopened, the product is removed.

The known mold groups typically consist of a plurality of components mutually joined to one another. Preferably, said components are known as half-molds. Said half-molds are typically joined by means of specially conformed and specially housed closing devices comprised in the mold group. In particular, said closing devices are integrally connected to one of the two half-molds and comprise at least one closing group controllable in closing to perform the mutual engagement of the two half-molds or in opening to allow the mutual disengagement thereof.

A typical problem encountered in molding is related precisely to the efficiency of the aforesaid closing devices. Indeed, a series of drawbacks have been found on the known closing devices which affect the correct closing of the mold group itself. Such a situation is particularly undesirable because it implies the production of a non-compliant product which must thus be discarded.

Furthermore, with particular reference to rotational molding, such drawbacks of the closing devices are because they are subject to movement together with the half-molds but above all are involved in the heating and cooling operations and are thus subject to high thermal excursions. Therefore, the known closing device solutions are subject to frequent replacement and maintenance of their parts subject to wear and tear and/or breakage.

### SUMMARY OF THE INVENTION

In view of the above, it is an object of the present invention to provide a closing device for a mold group of a molding system, preferably of the rotational type, which solves the aforesaid drawbacks.

Such an object is achieved by a closing device, a mold group and a molding system, preferably of the rotational type, as described and claimed herein.

Preferred variants implying further advantageous aspects are also described.

### BRIEF DESCRIPTION OF THE FIGURES

Further features and advantages of the invention will be apparent from the description provided below of preferred embodiments thereof, given by way of non-limiting examples, with reference to the accompanying drawings, in which:

FIGS. 1 and 1a show a perspective view and a section perspective view of a closing device, in a closing configuration, according to a preferred embodiment;

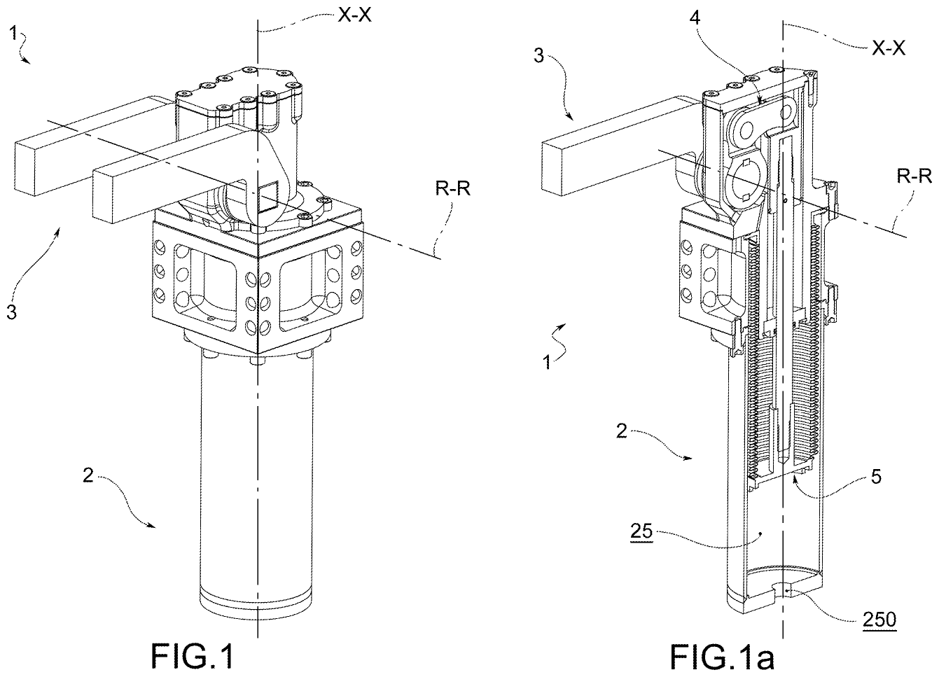

FIGS. 2 and 2a show a perspective view and a section perspective view of the closing device in FIGS. 1 and 1a, in an opening configuration, according to a preferred embodiment;

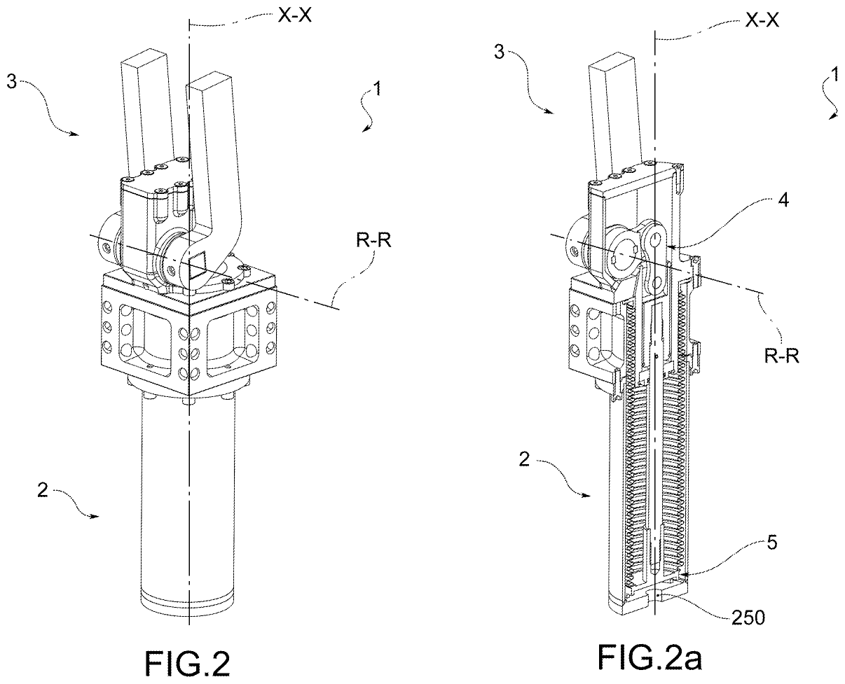

FIG. 3 is a front view of the closing device in FIGS. 1 and 1a;

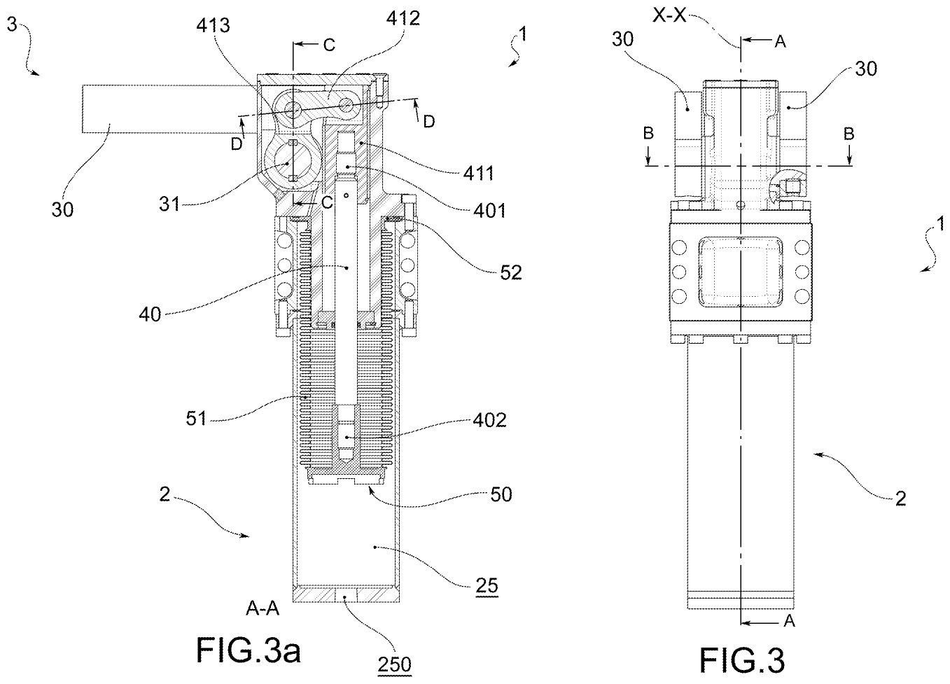

FIGS. 3a, 3b, 3c, and 3d show some section views of the closing device taken along section planes A-A, B-B in FIG. 3, and section planes C-C and D-D in FIG. 3a, respectively;

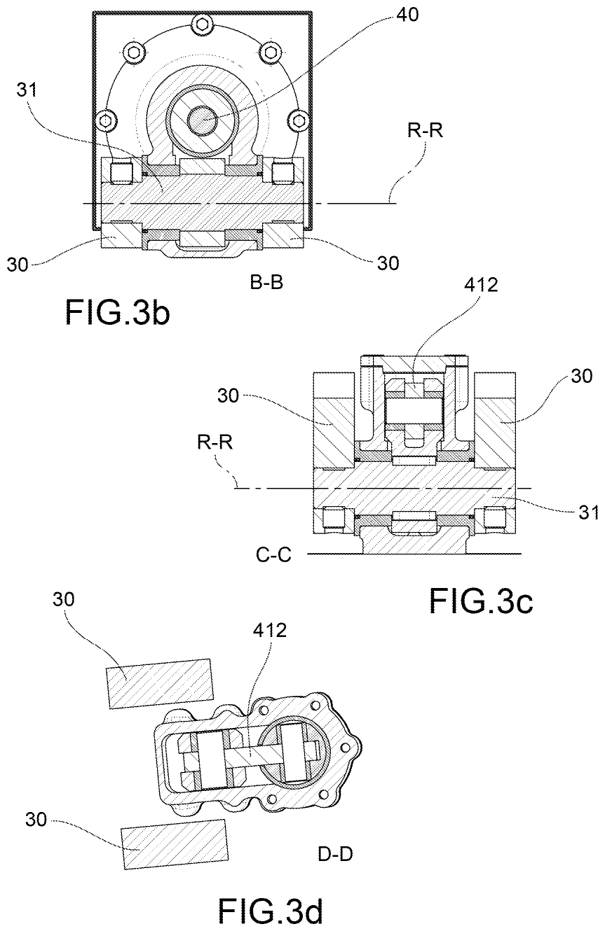

FIGS. 4, 4a′ and 4a″ show a perspective view and two section views of a closing device, in a closing configuration, according to a preferred embodiment;

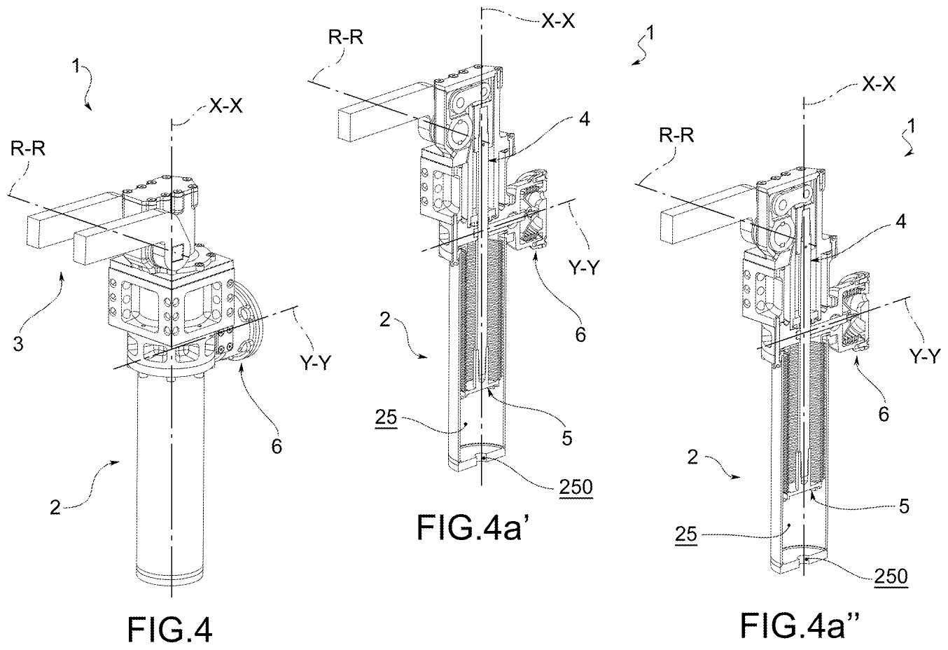

FIGS. 5, 5a′ and 5a″ show a perspective view and two section views of a closing device in FIGS. 4, 4a′ and 4a″, in an opening configuration, according to a preferred embodiment;

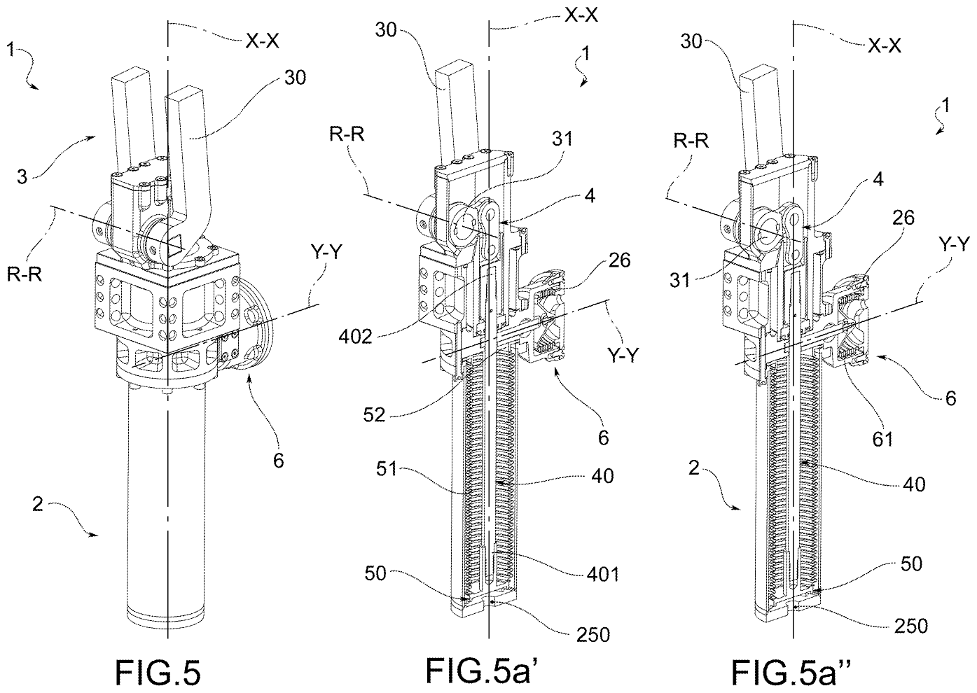

FIG. 6 is a front view of the closing device in FIGS. 4, 4a′ and 4a″;

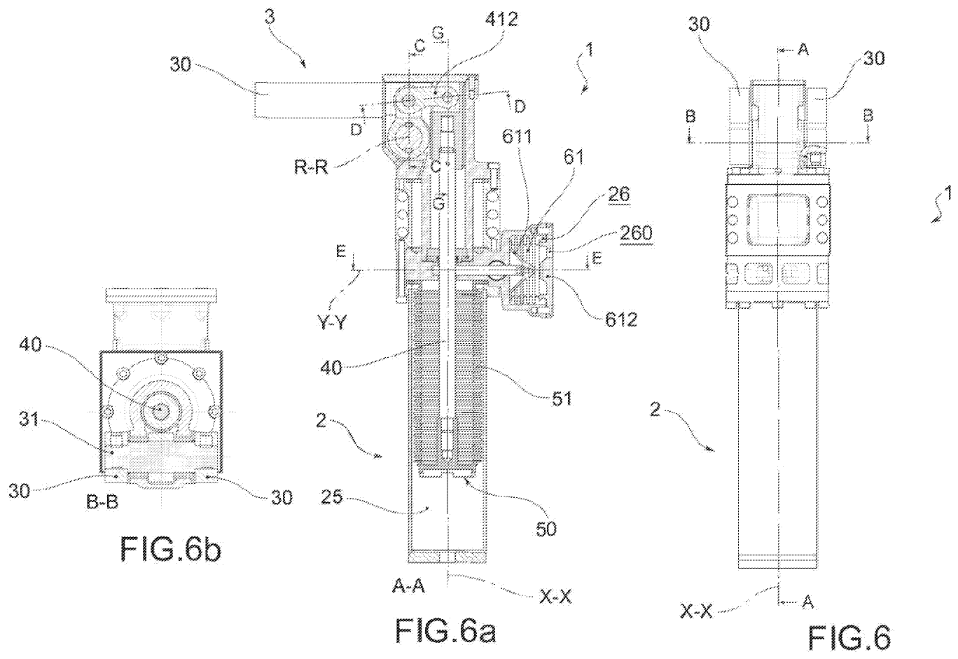

FIGS. 6a, 6b, 6c, 6d, 6e, and 6g show some section views of the closing device taken along section planes A-A, B-B in FIG. 6, and section planes C-C, D-D, E-E, and G-G in FIG. 6a, respectively;

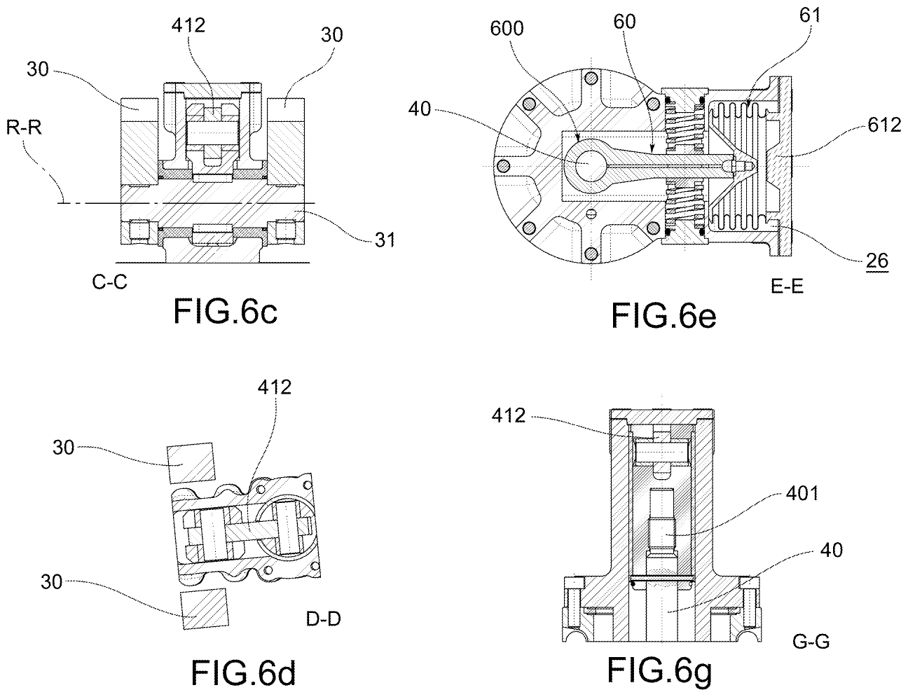

FIG. 7 shows a diagrammatic of a rotational molding system which comprises a mold group, according to a preferred embodiment; and

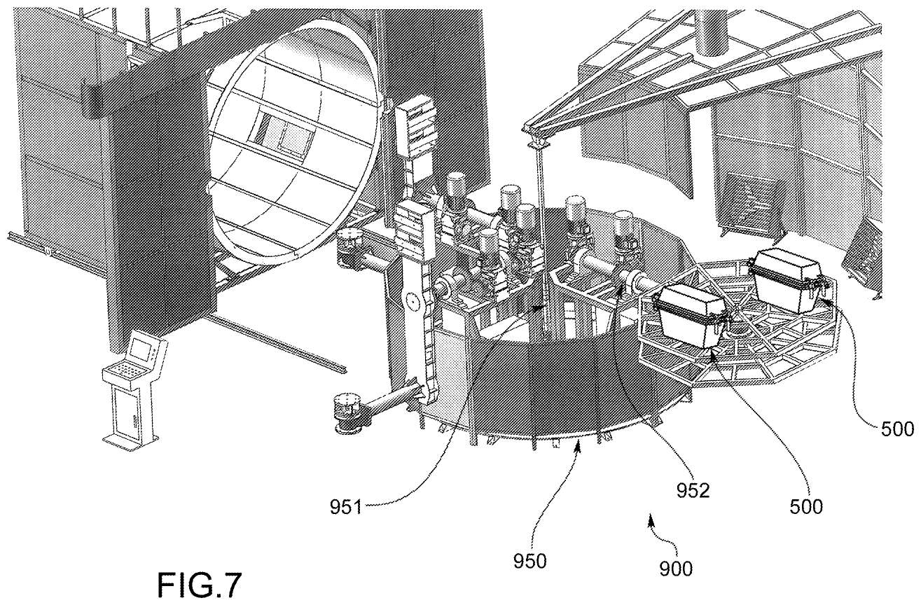

FIG. 8 shows a mold group according to the present invention.

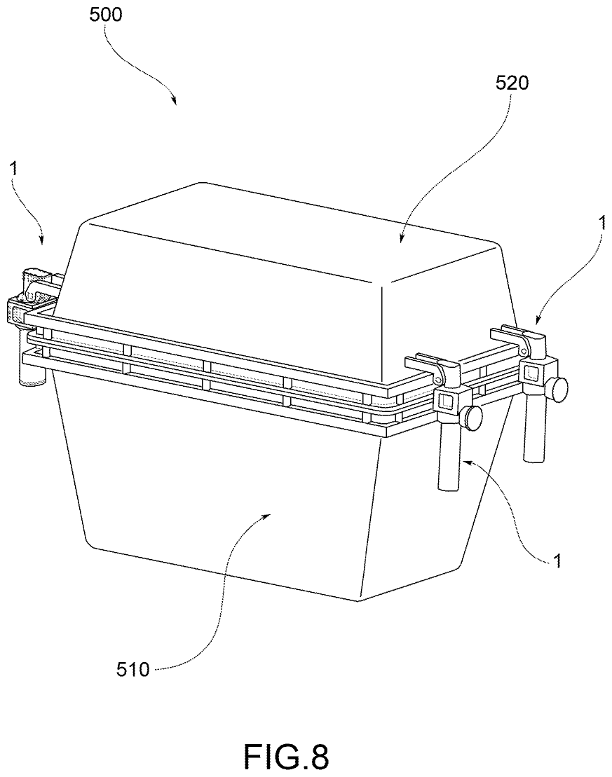

### DETAILED DESCRIPTION

In the accompanying figures, reference numeral 1 indicates a closing device, according to the present invention.

The present invention further relates to a mold group 500 which comprises at least one closing device 1. Preferably, the mold group 500 comprises two half-molds 510, 520.

Furthermore, it is a further object of the present invention a molding system 900, preferably of the rotational type, comprising a mold group 500 which in turn comprises at least one closing device 1.

According to a preferred embodiment, the molding system 900 comprises a machine 950 suitable for housing and moving the mold 500 group. Preferably, the machine 950 comprises a base frame which supports a first movable frame 951 suitable for rotating about a first rotation axis, e.g. vertical. Furthermore, the machine 950 preferably comprises a second movable frame 952, supported by the first movable frame 951, wherein the second movable frame 952 is suitable for rotating about a second preferably horizontal rotation axis.

According to a preferred embodiment, the machine 950 comprises first motion means suitable for moving the first movable frame 951 relative to the base frame and second motion means suitable for moving the second movable frame 952 relative to the first movable frame 951.

According to a preferred embodiment, the mold group 500 can be housed on the second movable frame 952.

According to a preferred embodiment, the system 900 comprises heating means, such as an oven, suitable for heating the mold group 500.

According to a preferred embodiment, the system 900 comprises cooling means, e.g. fans, adapted to cool the mold group 500.

Furthermore, according to a preferred embodiment, the molding system 900 further comprises air supplying means. Preferably, the air supplying means are suitable for pneumatically supplying the closing device 1 in the manner fully described below. Preferably, the air supplying means comprise appropriate conduits or pipes through which the air can be supplied to the closing device 1 or closing devices 1.

According to the present invention, the closing device 1 extends along a main axis X-X. Preferably, one portion is mountable integrally with one half-mold 510 and another portion is suitable for operating with the other half-mold 520.

Preferably, the axial end portion is mountable integrally with a half-mold 510, e.g. on its body or on a supporting frame in which the half-mold 510 is integrally housed.

According to the present invention, the closing device 1 comprises a main body 2.

Preferably, the main body 2 is mountable integrally with at least one half-mold 510, 520. Preferably, the main body 2 is suitable for entirely housing, partially housing and/or supporting the components described below, comprised in the closing device 1 as described below and shown in the figures by way of non-limiting example.

According to the present invention, the main body 2 is suitable for being connected to the air supplying means.

Indeed, the main body 2 preferably comprises a command chamber 25 suppliable by the air supplying means. According to a preferred embodiment, the main body 2 comprises a supply port 250 fluidically connected to the command chamber 25. Preferably, the supply port 250 is proximal to an axial end of the closing device 1. According to a preferred embodiment, the supply port 250 is positioned at the main axis X-X.

According to the present invention, the closing device 1 comprises a first closing group 3 suitable for operating with a half-mold.

In particular, the closing group 3 is positioned at one end of the device body 2; preferably, the closing group 3 is positioned at the end of the device body 2 opposite to the end in which the command chamber 25 is formed.

According to the present invention, the closing group 3 comprises at least one closing element 30 rotatable about a rotation axis R-R between a closing position and an opening position.

In the closing position, the closing element 30 is arranged substantially orthogonal to the main axis X-X and the two half-molds 510, 520 are mutually lockable.

In the opening position, the closing element 30 is arranged substantially parallel to the main axis X-X and the two half-molds 510, 520 are mutually releasable.

According to a preferred embodiment, the closing group 3 comprises a pin element 31 extending along the rotation axis R-R.

Preferably, the closed element 30 is integrally connected to the pin element 31.

According to a preferred embodiment, the closing group 3 comprises two closing elements 30 positioned at the axial ends of the pin element 31.

Preferably, the two closing elements 30 are movable in the same angular positions relative to the rotation axis R-R. In other words, the two closing elements 30 are positioned mirroring each other.

According to a preferred embodiment, the pin element 31 is partially housed in the main body 2, in a central portion thereof, so that the closing elements 30 are engaged at the axial ends of the pin element 31 which protrude from the main body 2.

According to the present invention, the closing device 1 further comprises a movement group 4 suitable for moving the closing group 3.

The movement group 4 is housed in the device body 2 and is operatively connected to the closing group 3, in particular to the pin element 31.

The movement group 4 comprises a stem 40 movable along the main axis X-X and transmission members 41 engaged with the stem 40 and the closing group 3 suitable for transforming the linear motion of the stem into rotational motion of the pin element 31. In other words, an axial position of the stem 40 corresponds to a specific angular position of the closing element 30.

Preferably, the transmission members 41 are engaged to a closing end 401 of the stem 40 and to the pin element 31. Preferably, the transmission members 41 comprise a cylindrical element 411 fixed to the closing end 401, a rotation element 413 fixed to the pin element 31, and a transmission linkage 412 hinged to the cylindrical element 411 and the rotation element 413.

According to the present invention, the closing device 1 comprises a command group 5 suitable for commanding the movement, and consequently the axial position, of the stem 40.

The command group 5 is controllable by the air supplying means and is suitable for transmitting the action of the air supplying means to the stem 40.

Indeed, the command group 5 is housed in the command chamber 25 comprised in the device body 2 in which the stem 40 is also at least partially housed.

The command group 5 comprises a command plate 50 engaged to a command end 402 of the stem 40.

Furthermore, the command group 5 comprises a metal sealing bellows 51 engaged with the command plate 50 so that a position of the metal sealing bellows 51 corresponds to an axial position of the command plate 50, and thus of the stem 40.

Indeed, the metal sealing bellows 51 preferably divides the command chamber 25 into two distinct half-chambers 251, 252 which are mutually separated and sealed.

According to a preferred embodiment, with the metal sealing bellows 51 compressed, the closing element 30 is in the closing position, while with the metal sealing bellows 51 extended, the closing element 30 is in the opening position.

According to a preferred embodiment, the metal sealing bellows 51 is normally in an extended position.

Preferably, in the absence of air thrust produced by the air supplying means, the metal sealing bellows 51 is arranged in an extended position, and the closing group 3 in an open configuration.

Preferably, in the absence of air thrust produced by the air supplying means, the metal sealing bellows 51 autonomously performs a return action towards the extended configuration. According to a preferred embodiment, by virtue of the presence of the metal sealing bellows 51 and its mode of operation, there is no need for return means, e.g. such as a coil spring, needed to return the command plate 50 and thus the stem 40, to an extended configuration, and thus of opening of the closing group 3.

According to a preferred embodiment, the air supplying means are suitable for creating a vacuum in the command chamber 25 to facilitate the passage of the metal sealing bellows 51 between the compressed condition and the extended condition.

According to a preferred embodiment, the metal sealing bellows 51 extends about the stem 40.

Preferably, the metal sealing bellows 51 is located at a position axially opposite to the air inlet, i.e., is axially spaced apart from the supply port 250.

According to a preferred embodiment, the metal sealing bellows 51 is engaged at an end to the command plate 50, while at the other end, it comprises a closing plate 52 suitable for axially closing the command chamber 25.

Preferably, the stem 40 extends through the closing plate 52.

According to a preferred embodiment, the closing device 1 further comprises a safety group 6 suitable for operating on the movement group 4 to lock it in a preferred configuration.

Preferably, in turn, the safety group 6 is controllable by the air supplying means.

Preferably, the safety group 6 is suitable for operating on the stem 40 to lock and hold it in a preferred axial position.

According to a preferred embodiment, the safety group 6 extends along a safety axis Y-Y. Preferably, the safety axis is substantially orthogonal to the main axis X-X.

According to a preferred embodiment, a safety group 6 comprises a safety element 60 positionable in a safety position, in which it engages the stem 40 and keeps it in an axial position, and a release position, in which it is disengaged from the stem 40, which is free to move axially.

In other words, the safety group 6 is suitable for operating on the stem 40 to inhibit or allow the axial movement thereof.

According to a preferred embodiment, the safety group 6 is positioned in an axial position between the command group 5 and the closing group 3.

Preferably, the safety group 6 engages the stem 40 in a region before the region in which the transmission members 41 are located.

Preferably, the safety group 6 comprises a metal safety bellows 61 engaged to the safety element 60. Preferably, a position of the metal safety bellows 61 corresponds to an axial position of the safety element 60 and thus to whether or not the safety group 6 is engaged to the movement group 4.

According to a preferred embodiment, with the metal safety bellows 61 compressed, the safety element 60 is in the safety position, and with the metal safety bellows 61 extended the safety element 60 is in the release position.

According to a preferred embodiment, the metal safety bellows 61 is normally in a compressed position. In other words, in the absence of action of the air, the metal safety bellows 61 is extended and the safety element 60 is in the released position.

In other words, the metal safety bellows 61 is suitable for operating oppositely to the metal sealing bellows 51 (in the embodiments in which it is provided).

According to a preferred embodiment, the safety group 6 is pneumatically commanded in the safety position to hold the closing group 3 in a preferred position, preferably in the closing position.

According to a preferred embodiment, the safety element 60 is of the band type, comprising an annular portion 600 which extends around the stem 40, wherein the safety position corresponds to the annular portion 600 radially tightened onto the stem 40 and the release position corresponds to the annular portion 600 radially spaced apart from the stem 40.

According to a preferred embodiment, the main body 2 comprises a safety chamber 26 in which the metal safety bellows 61 is housed. Preferably, the safety element 60 is also at least partially housed in the safety chamber 26.

According to a preferred embodiment, the metal safety bellows 61 comprises an end cap 612 at an axial end suitable for axially closing the safety chamber 26 and a safety plate 611 integrally connected to the safety element 60.

Preferably, the end cap 612 comprises an auxiliary supply port 260 fluidically connected to the safety chamber 26. Preferably, the auxiliary supply port 260 is connectable to the air supplying means.

Additional embodiments of the closing device 1 are possible.

In particular, embodiments are possible in which the main body 2 is in a single body, as well as embodiments (such as those shown in the accompanying figures) in which the main body 2 consists of a plurality of parts and portions.

Innovatively, the closing device, the mold which comprises said closing device, as well as the molding system described above, amply fulfill the scope of the present invention by solving the problems raised in typical solutions of the prior art.

Advantageously, the closing device maintains the locking position over time.

Advantageously, the closing device resists the typical movements of rotational molding.

Advantageously, the closing device resists the temperature changes typical of rotational molding.

Advantageously, the closing device has a limited number of components.

Advantageously, the closing device does not have specific sealing elements which are instead present in known closing device solutions.

Advantageously, the closing device shows an extremely longer life cycle compared to the life cycle of known closing devices.

Advantageously, the closing device requires far less maintenance.

Advantageously, the closing device is pneumatically controllable in a simplified manner.

Advantageously, the mold group which comprises at least one closing device according to the above, in turn, achieves the aforesaid advantageous technical effects.

Advantageously, in turn, the molding system, in which the mold group mounts at least one closing device according to the description, achieves the above-mentioned advantageous technical effects.

Advantageously, the aforesaid technical effects are mainly found in a rotational type molding system.

It is apparent that a person skilled in the art may make changes to the object of the present invention, all contained within the scope of protection as defined in the following claims to satisfy contingent needs.

1. A closing device for a mold group of a molding system, wherein the mold group comprises two half molds, and wherein the closing device extends along a main axis and comprises:
a device body mountable to one of the two half-molds;
a closing group, positioned at one end of the device body, comprising at least one closing element rotatable about a rotation axis between a closing position, in which the at least one closing element is arranged substantially orthogonal to the main axis and the two half-molds are mutually lockable and an opening position, in which the at least one closing element is arranged substantially parallel to the main axis and the two half-molds are mutually releasable;
a movement group housed in the device body and engaged with the closing group to rotationally move the at least one closing element, wherein the movement group comprises a stem movable along the main axis and transmission members engaged with the stem and with the closing group, suitable for transforming a linear motion into a rotatory motion; and
a command group housed in a command chamber comprised in the device body, the command group being controllable by air supplying means and comprising a command plate engaged with a command end of the stem and a metal sealing bellows engaged with the command plate so that a position of the metal sealing bellows corresponds to an axial position of the command plate, and therefore of the stem.

2. The closing device of claim 1, wherein with the metal sealing bellows compressed, the at least one closing element is in the closing position, while with the metal sealing bellows extended, the at least one closing element is in the opening position.

3. The closing device of claim 1, wherein the metal sealing bellows extends around the stem.

4. The closing device of claim 1, wherein the metal sealing bellows is integrally connected to the command plate at one end, and at the other end, the metal sealing bellows comprises a closing plate suitable for axially closing the command chamber.

5. The closing device of claim 1, wherein the closing group comprises a pin element extending along the rotation axis, wherein the at least one closing element is solidly fixed to the pin element, and wherein the movement group acts upon the pin element.

6. The closing device of claim 5, wherein the closing group comprises two closing elements positioned at axial ends of the pin element.

7. The closing device of claim 1, further comprising:
a safety group that extends along a safety axis substantially orthogonal to the main axis, the safety group being controllable by a the air supplying means and comprising a safety element positionable in a safety position, in which the safety element engages the stem and keeps the stem in an axial position, and a release position, in which the safety element is disengaged from the stem, which is free to move axially.

8. The closing device of claim 7, wherein the safety group comprises a metal safety bellows engaged with the safety element, wherein with the metal safety bellows compressed, the safety element is in the safety position, while with the metal safety bellows extended, the safety element is in the release position.

9. The closing device of claim 7, wherein the safety element is of the band type, and comprises an annular portion extending around the stem, wherein the safety position corresponds to the annular portion radially tightened onto the stem and the release position corresponds to the annular portion radially spaced apart from the stem.

10. A mold group of a molding system, comprising two half-molds and at least one closing device according to claim 1.

11. A molding system, comprising a mold group comprising two half-molds and at least one closing device according to claim 1.

12. The closing device of claim 1, wherein the molding system is of rotational type.
